(19) United States
(12) Patent Application Publication
(10) Pub. No.: US 2016/0353548 A1
(43) Pub. Date: Dec. 1, 2016

(54) Illumination device for a door lock tumbler

(71) Applicant: Stanley Davis, Aurora, CO (US)

(72) Inventor: Stanley Davis, Aurora, CO (US)

(21) Appl. No.: 15/166,382

(22) Filed: May 27, 2016

Related U.S. Application Data
(60) Provisional application No. 62/166,668, filed on May 26, 2015.

(51) Int. Cl. H05B 37/02; H05B 33/08; E05B 17/10; F21V 33/00

(52) U.S. Cl. CPC H05B 37/0218; H05B 37/0272; F21V 33/006; H05B 33/0854; E05B 17/10

(57) ABSTRACT

A plurality of light emitting diodes (LEDs), a sensor, a wireless receiver, and a power supply unit comprises an illumination device for a door lock tumbler. The sensor detects sunlight and activates the LEDs in the absent of sunlight. A user may activate the LEDs by using a remote control, which communicates with the wireless receiver. The power supply unit powers the device and may use solar cells, batteries, or other sufficient means to supply electricity to the device.

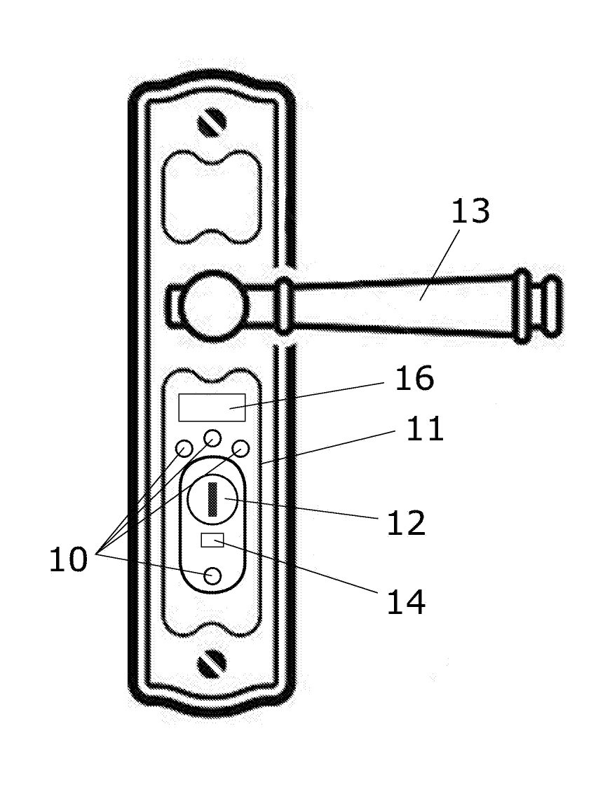

### CROSS-REFERENCE TO RELATED APPLICATIONS

This Application claims the benefit of U.S. Provisional Application No. 62/166,668, filed May 26, 2015, which is hereby incorporated by reference.

### STATEMENT REGARDING FEDERALLY SPONSORED RESEARCH OR DEVELOPMENT

Not Applicable

### PARTIES TO A JOINT RESEARCH AGREEMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The invention relates generally to illumination devices and in particular to an illumination device for a door lock tumbler. Upon arriving home late at night after a difficult day, few homeowners have the patience to fumble around in the darkness, searching for the keyholes in their own front doors. Unfortunately, due to the layout of the doorway, the door lock tumbler is frequently in shadow even if a nearby light has been activated. In some circumstances, the ability to quickly unlock the door and traverse the threshold to the safety of one's home may make the difference between becoming the victim of a crime, and spending an uneventful evening at home.

A search of the prior art reveals various illumination devices which have been developed to provide sufficient light to unlock the external door of an office or residence. None are closely related to the present invention, but several include features which resemble those of the present invention. Each has proven to be less than satisfactory in its own way. The present invention has been developed for the purpose of addressing and resolving these disadvantages.

Door handle and lock illuminating device, U.S. Pat. No. 7,832,887 (priority Jun. 11, 2007), provides apparatus, methods, and other embodiments associated with illuminating door handles and door lock mechanisms. In one embodiment of a door-illuminating device for illuminating a locking mechanism that is secured to a door and illuminating a door handle that is secured to the door, the device includes a housing, a light source, a source of power, a first opening in the housing, and a second opening in the housing. The housing is secured to the door and the light source and power source are secured within the housing, where the power source is in electrical communication with the light source. The first opening may selectively direct light emitted from the light source to the locking mechanism, and a second opening may selectively direct light emitted from the light source to the door handle.

Illuminating mechanism for a lock, U.S. Pat. No. 7,367,683 (priority Mar. 11, 2004), provides a lock including an illuminating device which is actuated by the rotation of a lock dial, producing an illumination event. The illumination event provides sufficient light on the lock such as to allow easier operation of the lock in areas of inadequate light. The lock may include a piezo device which creates electrical current to light one or more light emitting diodes (LEDs) for a predetermined duration of time.

Remotely actuated door lock light, U.S. Pat. No. 5,535,104 (filed Aug. 11, 1995), provides a door lock assembly comprising a lock plug having a key receiving opening, selectively operable light source for illuminating the key receiving opening, RF receiver for reproducing a received pulsed RF signal and means for determining whether the reproduced RF signal is within an acceptable range of asymmetric patterns of “on” pulse times followed by “off” times. The “on” times and “off” times are selected to include a plurality of different asymmetric patterns and means for operating the light source means for a selected period of time when the determining means determines that the reproduced RF signal is within acceptable range.

Illuminated doorknob lock, U.S. Pat. No. 4,777,570 (filed Feb. 5, 1987), provides a doorknob lock set, including an elongated stem which extends through a transverse opening in the door and is rotatable about its longitudinal axis to actuate the door latch. Doorknobs are provided at both ends of the stem to rotate the stem; and the stem includes a key lock mechanism including a key slot at the outer end of the stem. To illuminate the key lock slot, the outer doorknob is replaced by a knob fabricated from a translucent material. The translucent knob is provided with a central bore to receive the outer end of the stem; and the knob is mounted on the stem to frame the key slot. The knob is provided with at least one cavity opening from the inner face of the knob and extending toward the outer face. An illuminating device such as an incandescent bulb is placed in that cavity. Electric conductors connected to the illuminating device extend out of the cavity for connection to a source of electric energy. The source of electric energy may be a battery pack, with or without switch, mounted on the door adjacent to the exterior doorknob, or may be connected to wiring of the building structure such as the doorbell circuit.

Door lock lighting device, Chinese Patent No. CN204386278 (filed Nov. 28, 2011), provides a door lock lighting device which comprises a door lock body and a remote controller. A lighting lamp is arranged on the door lock body, and a power source, a signal receiver, a controller and a power switch are arranged in the door lock body. The power source is connected with the signal receiver, the controller and the power switch, the controller is connected with the signal receiver and the power switch, the power switch is connected with the lighting lamp, a signal transmitter is arranged in the remote controller, an opening corresponding to the position of the power source is formed in the door lock body, a door cover capable of covering the opening is arranged on the opening, the power source comprises a power source box and a battery, and the battery is arranged in the power source box. The user may control the working state of the lighting lamp through the remote controller, and when the power source is expended, the door cover can be opened, and the battery in the power source box can be replaced through the opening.

Door frame with integrated keyless entry system, U.S. Pat. No. 6,023,224 (filed Jul. 29, 1997), provides an entry control and security system in the form of a pre-assembled door and door frame unit. The door frame unit provides an electric light, a motion detector, a radiant energy receiver and an electromechanically actuated latch, all disposed on and built into the door frame. The invention provides an economically manufactured and easily installed unit which allows persons to unlatch a door by remote control in order to gain access to a building, as well as providing illumination in the vicinity of the doorway during periods of darkness. A radiant energy receiver, such as a radio frequency receiver, is disposed on the door frame and is electrically coupled with at least one electromechanical door latch also disposed on the frame. A keychain-sized remote control transmitter unit is carried by a person desiring access to the building. When a button on the remote control unit is pressed, the remote control unit transmits a coded signal which is received by the radiant energy receiver. If the signal bears the proper code, the latch is actuated to unlatch the door, allowing it to be pushed open with no further fumbling with keys, door knobs or manually actuated latches.

Most of these inventions are powered by batteries and rapidly expend the battery power. Further, many of the existing inventions are “always on.” This creates a disadvantage by causing the batteries to be discharged, rendering the illumination device inoperable at inconvenient times and requiring frequent and inconvenient battery changes. The proliferation of small, high-capacity, but inexpensive solar cells and light sensors, which may be used to detect sunlight or other ambient light and activate the illumination feature of the device in the absence of such ambient light, has pointed the way to a solution. The present invention resolves the disadvantages of the prior art and is not anticipated by the prior art.

An illumination device for a door lock tumbler, which casts sufficient light on the keyhole for the user to quickly and effortlessly unlock the door and enter, would resolve this problem.

### SUMMARY OF THE INVENTION

Accordingly, the invention is directed to an illumination device for a door lock tumbler. The device is comprised of a plurality of light emitting diodes (LEDs), a sensor, a wireless receiver, and a power supply unit. The sensor detects sunlight or other ambient light and activates the LEDs in the absent of such ambient light. A user may activate the LEDs by using a remote control, which communicates with the wireless receiver. The power supply unit powers the device and may use solar cells, batteries, or other sufficient means to supply electricity to the device.

Additional features and advantages of the invention will be set forth in the description which follows, and will be apparent from the description, or may be learned by practice of the invention. The foregoing general description and the following detailed description are exemplary and explanatory and are intended to provide further explanation of the invention.

### BRIEF DESCRIPTION OF THE DRAWING

The accompanying drawing is included to provide a further understanding of the invention and is incorporated into and constitutes a part of the specification. It illustrates one embodiment of the invention and, together with the description, serves to explain the principles of the invention.

The FIGURE shows a front view of a door lock with the first exemplary embodiment installed, displaying the LEDs 10, the lock 11, the tumbler 12, and the doorknob 13.

### DETAILED DESCRIPTION OF THE INVENTION

Referring now to the invention in more detail, the invention is directed to an illumination device for a door lock tumbler 12.

It is to be understood that while the invention is intended for use with a door lock tumbler on a residential or commercial property, this is not intended as a limitation. With suitable modifications or with no modification at all, the invention may be used with any keyed lock, including automotive locks.

The invention is intended for installation as original equipment by the manufacturer of the lock 11. An alternate embodiment, intended for installation as an after-market modification by the user, or by a locksmith or other craftsman, is contemplated.

The first exemplary embodiment is comprised of a plurality of light emitting diodes (LEDs) 10, a sensor 14, a wireless receiver, and a power supply unit 16. The LEDs are preferably arranged with three LEDs 10 in an arc above the tumbler 12, and one LED 10 centered immediately below the tumbler 12. Alternate embodiments, which provide the same or a different quantity of LEDs 10 arranged in different patterns, are contemplated. The device is provided with LEDs 10 in a variety of colors.

The sensor 14 detects sunlight or other ambient light and activates the LEDs 10 in the absent of such ambient light. A user may also activate the LEDs 10 by using a remote control, which communicates with the wireless receiver 15. The power supply unit 16 powers the device and may use solar cells, batteries, or other sufficient means to supply electricity to the device.

Electronic components of the device include the LEDs 10, the sensor 14, the receiver 15 which operates on a radio frequency (RF) or other short-range wireless communications protocol, an internal ring antenna, and the power supply unit 16.

To use the first exemplary embodiment, the user may activate the LEDs 10 using the remote control. The user may then insert a key into the tumbler 12, unlock the door lock 11, turn the doorknob 13, and open the door.

The LEDs 10 are preferably manufactured from a rigid, durable material which is transparent or translucent, such as plastic, glass, or methacrylate. The sensor, the receiver, and the power supply unit are preferably manufactured from rigid, durable materials, such as steel, aluminum alloy, copper alloy, brass, and plastic.

Components, component sizes, and materials listed above are preferable, but artisans will recognize that alternate components and materials could be selected without altering the scope of the invention.

While the foregoing written description of the invention enables one of ordinary skill to make and use what is presently considered to be the best mode thereof, those of ordinary skill in the art will understand and appreciate the existence of variations, combinations, and equivalents of the specific embodiment, method, and examples herein. The invention should, therefore, not be limited by the above described embodiment, method, and examples, but by all embodiments and methods within the scope and spirit of the invention.

I claim:

1. An illuminating device for a door lock tumbler, comprising:
a. a door lock;
b. a plurality of light emitting diodes;
c. a sensor;
d. said sensor measuring a light level on an exterior surface of the door lock;
e. a power supply unit;
f. said power supply unit providing power to said light emitting diodes;
g. said sensor activating the light emitting diodes if the light level drops below a predetermined brightness;
h. a wireless receiver; and
i. said wireless receiver being capable of activating the light emitting diodes when an activation signal is received.
